(19) United States
(12) Patent Application Publication
(10) Pub. No.: US 2015/0194872 A1
(43) Pub. Date: Jul. 9, 2015

(54) POWER SUPPLY DEVICE

(71) Applicant: SAMSUNG ELECTRO-MECHANICS CO., LTD., Suwon-Si (KR)

(72) Inventors: Man Dong LEE, Suwon-Si (KR); Yu Jin JANG, Suwon-Si (KR); Hwan CHO, Suwon-Si (KR); Joeng Mo YANG, Suwon-Si (KR)

(73) Assignee: SAMSUNG ELECTRO-MECHANICS CO., LTD., Suwon-Si (KR)

(21) Appl. No.: 14/293,708

(22) Filed: Jun. 2, 2014

(30) Foreign Application Priority Data
Jan. 3, 2014 (KR) 10-2014-0000752

(51) Int. Cl. H02M 1/08; H02M 3/156

(52) U.S. Cl. CPC H02M 1/08; H02M 3/156

(57) ABSTRACT

A power supply device may include a power supplying unit switching input power to supply power; a voltage detecting unit obtaining output voltage information related to the power supplying unit; a controlling unit outputting a feedback signal based on the output voltage information and controlling the switching of the power supplying unit based on the feedback signal; and a phase compensating capacitor stabilizing the feedback signal. The controlling unit may include a detector detecting whether or not the phase compensating capacitor is in an abnormal state based on the feedback signal.

### CROSS-REFERENCE TO RELATED APPLICATION

This application claims the benefit of Korean Patent Application No. 10-2014-0000752 filed on Jan. 3, 2014, with the Korean Intellectual Property Office, the disclosure of which is incorporated herein by reference.

### BACKGROUND

The present disclosure relates to a power supply device.

A switch-mode power supply (SMPS) is a device converting a direct current input voltage into a voltage having a square waveform using a semiconductor element such as a power transistor, or the like, as a switch and then obtaining a direct current output voltage through a filter.

In general, a high efficiency power supply system having a simple structure as well as a small size and stably supplying power is required for devices such as computers, printers, copy machines, monitors, communications terminals, and the like.

Therefore, a SMPS having advantages such as high efficiency, miniaturization and lightness has been widely used instead of a power stabilization apparatus according to the related art, by controlling a flow of power using a semiconductor element switching process.

### RELATED ART DOCUMENT

### 1) Korean Patent Laid-Open Publication No. 2008-0095740

2) Korean Utility model Laid-Open Publication No. 1998-028645

### SUMMARY

An aspect of the present disclosure may provide a power supply device capable of detecting an abnormal state.

An aspect of the present disclosure may also provide a power supply device capable of resetting a system in the case that an abnormal state is detected.

An aspect of the present disclosure may also provide a power supply device capable of providing improved stability.

According to an aspect of the present disclosure, a power supply device may include: a power supplying unit switching input power to supply power; a voltage detecting unit obtaining output voltage information related to the power supplying unit; a controlling unit outputting a feedback signal based on the output voltage information and controlling the switching of the power supplying unit based on the feedback signal; and a phase compensating capacitor stabilizing the feedback signal, wherein the controlling unit includes a detector detecting whether or not the phase compensating capacitor is in an abnormal state based on the feedback signal.

The power supplying unit may include at least one of a flyback converter, a forward converter, a half-bridge converter, a full-bridge converter, a push-pull converter, and a resonance type converter.

The controlling unit may include: an amplifier outputting the feedback signal based on the output voltage information and reference voltage information; and a signal generator outputting a control signal based on the feedback signal.

The detector may obtain differentiation information regarding the feedback signal and detect whether or not the phase compensating capacitor is in the abnormal state based on the differentiation information.

The detector may include a first n-type transistor turned on to allow a current to flow therethrough based on the feedback signal, an auxiliary capacitor connected to one terminal of the first n-type transistor, and a first p-type transistor connected to the other terminal of the first n-type transistor, and a gate of the first p-type transistor may be connected to a drain of the first n-type transistor, a source terminal of the first p-type transistor may be connected to a supply power source, and a drain terminal of the first p-type transistor may be connected to a reset terminal.

When a voltage level of the feedback signal rises, the first p-type transistor may be turned on to allow a current to flow therethrough.

The detector may output a reset signal when a gradient at which a voltage level of the feedback signal rises has a predetermined slope or greater.

The detector may reset the controlling unit in a case in which the phase compensating capacitor is determined to be in the abnormal state.

The detector may stop the controlling unit in a case in which the phase compensating capacitor is determined to be in the abnormal state.

The controlling unit may discharge the phase compensating capacitor in a case in which the phase compensating capacitor is determined to be in the abnormal state.

The controlling unit may allow a transistor connected to the phase compensating capacitor in parallel, to be turned on to thereby have a current flowing therethrough based on the differentiation information regarding the feedback signal.

According to another aspect of the present disclosure, a power supply device may include: a power supplying unit switching input power to supply power; a voltage detecting unit obtaining output voltage information related to the power supplying unit; a controlling unit including an amplifier outputting a feedback signal based on the output voltage information and reference voltage information and a signal generator outputting a control signal based on the feedback signal; and a phase compensating capacitor connected between an output terminal of the amplifier and a ground, wherein the controlling unit detects a state of connectivity between the phase compensating capacitor and the controlling unit based on the feedback signal.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a power supply device according to an exemplary embodiment of the present disclosure;

FIG. 2 is a diagram illustrating an example of a detector according to an exemplary embodiment of the present disclosure;

FIG. 3 is a diagram illustrating another example of a detector according to an exemplary embodiment of the present disclosure;

FIG. 4 is a diagram illustrating waveforms of respective units according to the detector shown in FIG. 3;

FIG. 5 is a diagram illustrating still another example of a detector according to an exemplary embodiment of the present disclosure;

FIG. 6 is a diagram illustrating waveforms of respective units according to the detector shown in FIG. 5;

FIG. 7 is a diagram illustrating an example of a controlling unit according to an exemplary embodiment of the present disclosure; and

FIGS. 8A and 8B are diagrams illustrating waveforms of respective units according to the controlling unit shown in FIG. 7.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

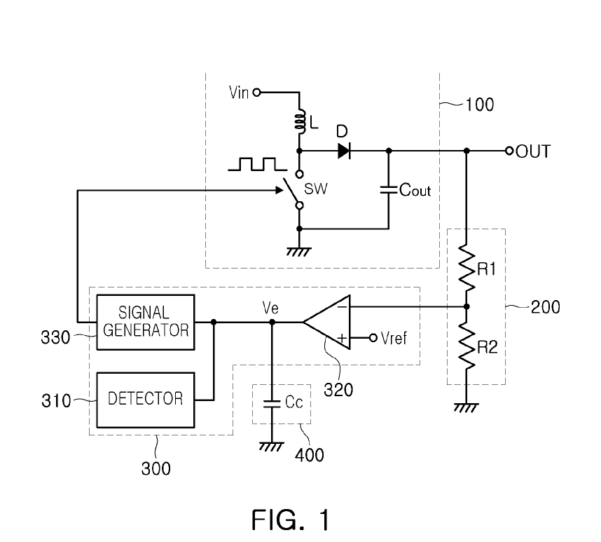

FIG. 1 is a diagram illustrating a power supply device according to an exemplary embodiment of the present disclosure.

Referring to FIG. 1, the power supply device may include a power supplying unit 100, a voltage detecting unit 200, a controlling unit 300, and a phase compensating capacitor 400.

The components shown in FIG. 1 are not essential components. Therefore, the power supply device may also be implemented to have more or less components than those illustrated in FIG. 1.

A configuration of the power supplying unit will be described based on a boost converter in the present specification for convenience of explanation.

However, it will be appreciated by those skilled in the art that a configuration according to exemplary embodiments of the present disclosure described in the present specification may be applied to a flyback converter, a forward converter, a half-bridge converter, a full-bridge converter, a push-pull converter, a resonance type converter, or the like.

The power supplying unit 100 may include a switch SW and may be operated in a switch-mode power supply (SMPS) scheme .

Referring to FIG. 1, an input terminal Vin to which power is input is connected to a reactor L for boosting an input voltage in series. In addition, the reactor L may be connected to a reverse current prevention diode D in series. In addition, a switch SW may be connected between the reactor L and the reverse current prevention diode D in parallel.

The switch SW may be turned on or off according to a control signal applied thereto to control the boosted voltage to be output to an output terminal Vout.

Meanwhile, the power supplying unit 100 may further include a capacitor element Cout for stabilizing an output voltage.

The voltage detecting unit 200 may detect the output voltage of the power supplying unit 100. For example, the voltage detecting unit 200 may include a plurality of resistors R1 and R2 connected in series between the output terminal Vout of the power supplying unit 100 and a ground. The voltage detecting unit 200 may detect the output voltage of the power supplying unit 100 through a voltage division performed by the plurality of resistors R1 and R2.

The controlling unit 300 may output a feedback signal based on output voltage information and may control the switch SW of the power supplying unit 100 based on the feedback signal.

For example, the controlling unit 300 may include an amplifier 320 outputting a feedback signal Ve based on the output voltage information and reference voltage information

Vref and a signal generator 330 outputting the control signal based on the feedback signal Ve.

The phase compensating capacitor 400 may be implemented between an output terminal of the amplifier 320 and a ground. In addition, the phase compensating capacitor 400 may stabilize the feedback signal to prevent the control signal from being oscillating. The phase compensating capacitor 400 may decrease a gain of the feedback signal in a high frequency region.

Meanwhile, the controlling unit 300 may further include a detector 310 detecting whether or not the phase compensating capacitor 400 is in an abnormal state based on the feedback signal Ve.

The controlling unit 300 is generally implemented as an integrated circuit IC, but since the phase compensating capacitor 400 has a large volume, the phase compensating capacitor 400 is generally implemented outside of the integrated circuit IC.

Therefore, the controlling unit 300 may be connected to the phase compensating capacitor 400 through a terminal. In this case, the phase compensating capacitor 400 and the controlling unit 300 may be disconnected due to a defective connection of the terminal.

The detector 310 may detect whether or not the phase compensating capacitor is in the abnormal state as described above. In other words, the detector 310 may detect a state of connectivity between the phase compensating capacitor 400 and the controlling unit 300.

Specifically, the detector 310 may obtain differentiation information regarding the feedback signal and may detect whether or not the phase compensating capacitor 400 is in the abnormal state based on the differentiation information.

For example, the detector 310 may determine that the connection state of the phase compensating capacitor 400 is abnormal when a voltage level of the feedback signal rises to a predetermined value or above for a preset period of time.

In this case, the detector 310 may reset the controlling unit 300 when the phase compensating capacitor 400 is determined to be in the abnormal state. For example, the detector 310 may output a reset signal when a gradient at which the voltage level of the feedback signal rises has a predetermined slope or greater.

In addition, the detector 310 may stop the controlling unit 300 when the phase compensating capacitor 400 is determined to be in the abnormal state.

According to the configuration described above, the power supply device according to an exemplary embodiment of the present disclosure may detect the abnormal state of the phase compensating capacitor 400. In addition, the power supply device may reset a system in the case that the abnormal state of the phase compensating capacitor 400 is detected and improve a degree of stability.

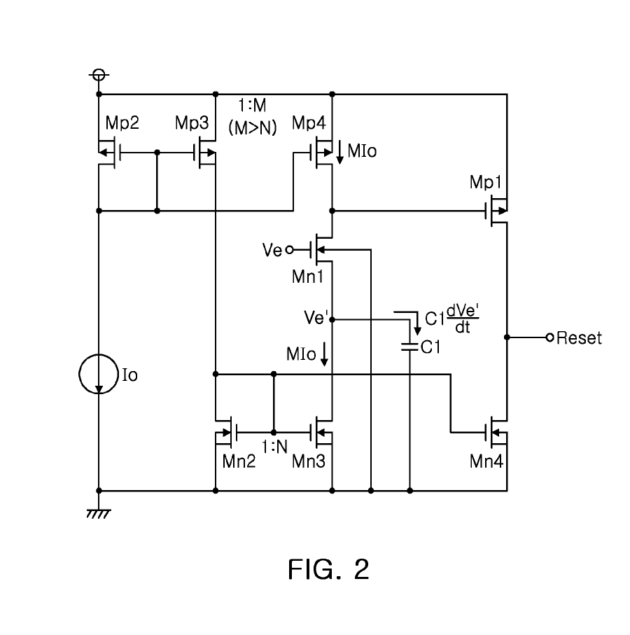

FIG. 2 is a diagram illustrating an example of a detector according to an exemplary embodiment of the present disclosure.

As illustrated in FIG. 2, the detector may include a plurality of p-type MOSFETs Mp1, Mp2, Mp3, and Mp4 and a plurality of n-type MOSFETs Mn1, Mn2, Mn3, and Mn4. Particularly, a relationship between a third p-type MOSFET Mp3 and a fourth p-type MOSFET Mp4 is as illustrated and a relationship between a second n-type MOSFET Mn2 and a third n-type MOSFET Mn3 is as illustrated.

Particularly, a first n-type MOSFET Mn1 may be turned on to allow a current to flow therethrough, based on the feedback signal Ve. In addition, a drain terminal of the first n-type MOSFET Mn1 may be connected to a gate of a first p-type MOSFET Mp1. A source terminal of the first n-type MOSFET Mn1 may be connected to an auxiliary capacitor C1.

In addition, a source terminal of the first p-type MOSFET Mp1 may be connected to a supply power source Vdd and a drain terminal of the first p-type MOSFET Mp1 may be connected to a reset terminal.

According to an exemplary embodiment of the present disclosure, in a case in which the voltage level of the feedback signal Ve is maintained at a constant value, a low level signal may be output from the reset terminal. However, in a case in which the voltage level of the feedback signal Ve is sharply increased, a high level signal may be output from the reset terminal.

Specifically, when the bulk effect of the first n-type MOSFET Mn1 (when being operated by a source follower) is ignored, the following relationship may be established.

dVe/dt=dVe′/dt

In this case, a current Idn1 in the drain terminal of the first n-type MOSFET Mn1 may be expressed by the following relationship.

Idn1=NIo+C1dVe′/dt

In this case, a value of the current Idn1 may be changed depending on a change in the voltage level of the feedback signal Ve. In a case in which the voltage level of the feedback signal is sharply increased, a current flow through the auxiliary capacitor C1 may be increased, such that the first p-type MOSFET mp1 may be turned on to allow a current to flow therethrough.

Meanwhile, in a case in which a relationship of MIo>Idn1is established, a gate voltage of the first p-type MOSFET Mp1 is increased and the first p-type MOSFET Mp1 is turned off, such that the low level signal may be output from the reset terminal.

In addition, in a case in which a relationship of Mio<Idn1 is established, the gate voltage of the first p-type MOSFET Mp1 is decreased and the first p-type MOSFET Mp1 is turned on, such that the high level signal may be output from the reset terminal.

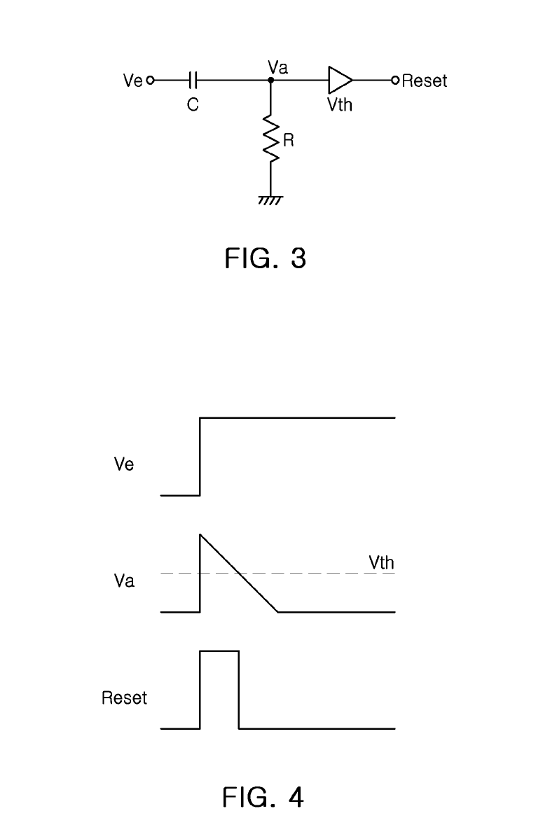

FIG. 3 is a diagram illustrating another example of the detector according to the exemplary embodiment of the present disclosure.

As illustrated in FIG. 3, the detector may include a capacitor element C, a resistor element R, and a comparator Vth. In this case, a connection relationship among the capacitor element C, the resistor element R, and the comparator Vth is as illustrated in FIG. 3 and one terminal of the capacitor element C may be connected to a feedback signal input terminal and an input terminal of the comparator Vth may be connected to the other terminal of the capacitor element C. In addition, the reset terminal may be connected to an output terminal of the comparator Vth. In addition, the resistor element R may be connected between a connection point of the capacitor element C and the comparator Vth and a ground.

Meanwhile, the comparator Vth may output the high level signal when an input signal has a predetermined level Vth or more.

FIG. 4 is a diagram illustrating waveforms of respective units according to the detector illustrated in FIG. 3.

As illustrated in FIG. 4, in a case in which the feedback signal Ve is sharply increased, a signal Va may be generated, and a reset signal may be output in a section in which the Va signal becomes the predetermined level Vth or more.

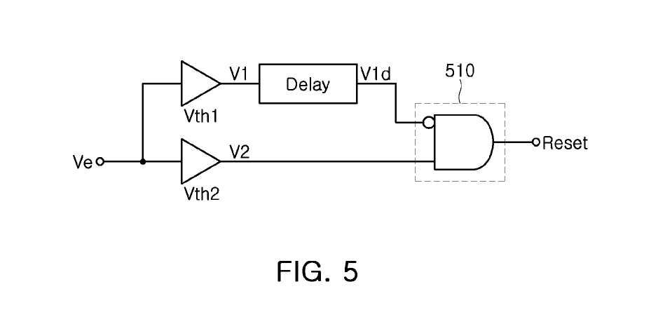

FIG. 5 is a diagram illustrating still another example of a detector according to an exemplary embodiment of the present disclosure.

As illustrated in FIG. 5, the detector may include a first comparator Vth1, a second comparator Vth2, a delay unit, and a signal outputting unit 510. Meanwhile, the comparator Vth1 may output a high level signal when an input signal has a predetermined level Vth1 or more. In addition, the comparator Vth2 may output a high level signal when an input signal has a predetermined level Vth2 or more.

Input terminals of the first comparator Vth1 and the second comparator Vth2 may be connected to the feedback signal input terminal.

An output terminal of the first comparator Vth1 may be connected to the signal outputting unit 510 via the delay unit. In addition, an output terminal of the second comparator Vth2 may be connected to the signal outputting unit 510.

The signal outputting unit 510 may output the reset signal based on a signal V1d transferred via the delay unit from the first comparator Vth1 and an output signal of the second comparator Vth2.

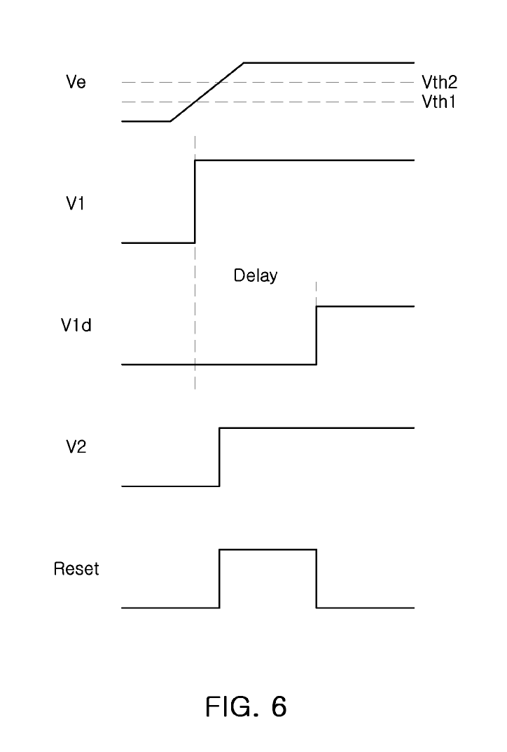

FIG. 6 is a diagram illustrating waveforms of respective units according to the detector shown in FIG. 5.

As illustrated in FIG. 4, in a case in which the voltage level of the feedback signal Ve is sharply increased, a signal V1, a signal V1d, and a signal V2 may be generated, and a reset signal may be output based on the signal V1d and the signal V2.

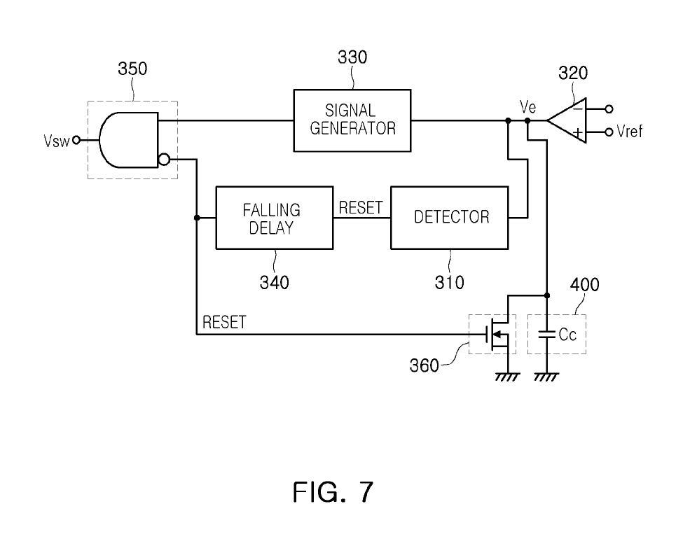

FIG. 7 is a diagram illustrating an example of a controlling unit according to an exemplary embodiment of the present disclosure.

Referring to FIG. 7, the controlling unit may include a falling delay unit 340, a signal outputting unit 350, and a transistor 360.

The falling delay unit 340 may output a maintained reset signal Reset' based on the reset signal Reset.

The signal outputting unit 350 may output a control signal Vsw based on the output signal of the signal generator 330 and the maintained reset signal Reset'. The controlling unit may be reset or stopped in abnormal situation according to the control signal Vsw.

In addition, the transistor 360 maybe controlled based on the maintained reset signal Reset'. That is, the transistor 360 may be connected to the phase compensating capacitor 400 in parallel. Therefore, in a case in which an abnormal situation is detected, the phase compensating capacitor may be discharged by an operation of the transistor 360.

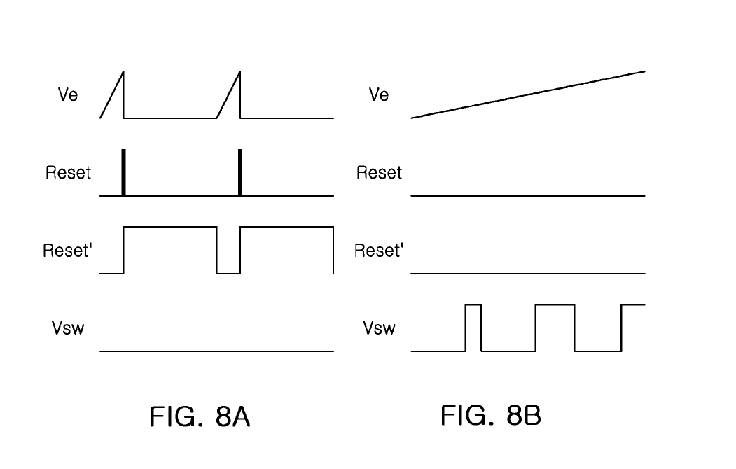

FIGS. 8A and 8B are diagrams illustrating waveforms of respective units according to the controlling unit illustrated in FIG. 7.

FIG. 8A is a diagram illustrating the respective units of the controlling unit in a case in which the abnormal situation is detected (for example, in a case in which a defective connection of the phase compensating capacitor occurs).

Referring to FIG. 8A, it may be appreciated that the phase compensating capacitor is discharged by the transistor 360 and a control signal Vsw having a low level is output. In this case, the controlling unit may be reset or stopped.

FIG. 8B is a diagram illustrating waveforms of the respective units of the controlling unit in a normal state.

Referring to FIG. 8B, it may be appreciated that the reset signal Reset is not output and the controlling unit is normally operated.

Through the configuration described above, the power supply device according to an exemplary embodiment of the present disclosure may detect an abnormal operation, reset a system in the case that the abnormal operation is detected, and improve a degree of stability.

As set forth above, according to exemplary embodiments of the present disclosure, a power supply device capable of detecting an abnormal state may be provided.

Further, a power supply device capable of resetting a system in the case that an abnormal state is detected may be provided.

Further, a power supply device capable of providing improved stability may be provided.

While exemplary embodiments have been shown and described above, it will be apparent to those skilled in the art that modifications and variations could be made without departing from the spirit and scope of the present disclosure as defined by the appended claims.

What is claimed is:

1. A power supply device comprising:
a power supplying unit switching input power to supply power;
a voltage detecting unit obtaining output voltage information of the power supplying unit;
a controlling unit outputting a feedback signal based on the output voltage information and controlling a switching of the power supplying unit based on the feedback signal; and
a phase compensating capacitor stabilizing the feedback signal,
wherein the controlling unit includes a detector detecting whether or not the phase compensating capacitor is in an abnormal state based on the feedback signal.

2. The power supply device of claim 1, wherein the power supplying unit includes at least one of a flyback converter, a forward converter, a half-bridge converter, a full-bridge converter, a push-pull converter, and a resonance type converter.

3. The power supply device of claim 1, wherein the controlling unit includes:
an amplifier outputting the feedback signal based on the output voltage information and reference voltage information; and
a signal generator outputting a control signal based on the feedback signal.

4. The power supply device of claim 3, wherein the detector obtains differentiation information regarding the feedback signal and detects whether or not the phase compensating capacitor is in the abnormal state based on the differentiation information.

5. The power supply device of claim 3, wherein the detector includes a first n-type transistor turned on to allow a current to flow therethrough based on the feedback signal, an auxiliary capacitor connected to one terminal of the first n-type transistor, and a first p-type transistor connected to the other terminal of the first n-type transistor, and
a gate of the first p-type transistor is connected to a drain of the first n-type transistor, a source terminal of the first p-type transistor is connected to a supply power source, and a drain terminal of the first p-type transistor is connected to a reset terminal.

6. The power supply device of claim 5, wherein when a voltage level of the feedback signal rises, the first p-type transistor is turned on to allow a current to flow therethrough.

7. The power supply device of claim 4, wherein the detector outputs a reset signal when a gradient at which a voltage level of the feedback signal rises has a predetermined slope or greater.

8. The power supply device of claim 4, wherein the detector resets the controlling unit in a case in which the phase compensating capacitor is determined to be in the abnormal state.

9. The power supply device of claim 4, wherein the detector stops the controlling unit in a case in which the phase compensating capacitor is determined to be in the abnormal state.

10. The power supply device of claim 4, wherein the controlling unit discharges the phase compensating capacitor in a case in which the phase compensating capacitor is determined to be in the abnormal state.

11. The power supply device of claim 10, wherein the controlling unit allows a transistor connected to the phase compensating capacitor in parallel, to be turned on to thereby have a current flowing therethrough based on the differentiation information regarding the feedback signal.

12. A power supply device comprising:
a power supplying unit switching input power to supply power;
a voltage detecting unit obtaining output voltage information related to the power supplying unit;
a controlling unit including an amplifier outputting a feedback signal based on the output voltage information and reference voltage information and a signal generator outputting a control signal based on the feedback signal; and
a phase compensating capacitor connected between an output terminal of the amplifier and a ground,
wherein the controlling unit detects a state of connectivity between the phase compensating capacitor and the controlling unit based on the feedback signal.
